(19) United States
(12) Patent Application Publication
(10) Pub. No.: US 2017/0050476 A1
(43) Pub. Date: Feb. 23, 2017

(54) TIRE-MONITORING DEVICE

(71) Applicant: GOFULL TECHNOLOGY CO., LTD., HSINCHU CITY (TW)

(72) Inventors: CHI-KANG LIU, HSINCHU CITY (TW); YUN-HUNG SHEN, HSINCHU CITY (TW)

(21) Appl. No.: 15/152,905

(22) Filed: May 12, 2016

(30) Foreign Application Priority Data
Aug. 20, 2015 (TW) 104127231

(51) Int. Cl. B60C 23/04; G01M 17/02

(52) U.S. Cl. CPC B60C 23/0455; B60C 23/0486; B60C 23/0479; B60C 23/041; B60C 23/0481; G01M 17/02

(57) ABSTRACT

A tire-monitoring device is arranged on a tire and includes a tire pressure sensor and a temperature sensor respectively sense tire pressure and temperature and respectively generate a tire pressure signal and a temperature signal received by a controller. When the controller determines that the tire pressure value continuously varies for a preset period or determines that a rising variation of the temperature value is larger than a preset variation, the controller generates a transmission control signal received by a wireless transmitter. The wireless transmitter transmits the tire pressure signal and the temperature signal to an external device, so as to display the tire pressure value and the temperature value. The present invention directly observes that the vehicle has started according to the continual variation of the tire pressure value and the variation of the temperature value and notifies the transmitter that the transmitter transmits the signal.

This application claims priority for Taiwan patent application no. 104127231 filed on Aug. 20, 2015, the content of which is incorporated by reference in its entirely.

### BACKGROUND OF THE INVENTION

Field of the Invention

The present invention relates to a monitoring system, particularly to a tire-monitoring device for measuring a state of a tire and effectively saving power.

Description of the Related Art

During a vehicle moves on, its tires easily deform due to insufficient tire pressure. Thus, contact areas between the tires and the ground increase to greatly wear the tires, whereby a tire life is reduced and blowout opportunities, friction and fuel consumption are increased. Besides, too much tire pressure can lower grip of the tires so that the vehicle easily skids. As a result, tire pressure is a very important part of driving safety.

In addition to tire pressure affecting a state of the vehicle, a temperature of the tires also affects the vehicle. The higher the temperature of the tires of the vehicle is, the lower the strength of the tires is. When the tires move, the tires are greatly deformed and worn to increase fuel consumption.

Consequently, a tire pressure monitoring system (I PMS) is presently provided in the market to detect the states of the tires. The TPMS timely informs a driver of tire pressure and temperature of the tires to maintain the tire pressure and temperature, thereby avoiding blowout accidents, improving driving safety and extending a tire life.

However, the TPMS now marketed uses a g-sensor to sense the start state of the vehicle whereby the vehicle starts to transmit a tire pressure signal. The g-sensor includes two live boards. One live board is fixed on a chip, and another live board is connected with a board through a spring. When acceleration occurs, the live board connected with the spring approaches or leaves the live board fixed on the chip, so as to establish different capacitances, thereby sensing gravity. The g-sensor still has some drawbacks. When in use, the spring breaks due to sudden acceleration. Alternatively, the two live boards attract each other to stick when rocking. Thus, the two live boards cannot be separated whereby the g-sensor malfunctions. Accordingly, the TPMS cannot transmit any signals. Alternatively, the TPMS endlessly transmits signals to damage the TPMS and increase power loss, thereby reducing a life of the TPMS.

To overcome the abovementioned problems, the present invention provides a tire-monitoring device, so as to solve the afore-mentioned problems of the prior art.

### SUMMARY OF THE INVENTION

A primary objective of the present invention is to provide a tire-monitoring device, which uses variations of a tire pressure value and temperature of a tire to start a transmitter lest an assembly be additionally installed to start the transmitter, and which avoids damaging the assembly or influencing transmission activities of the tire-monitoring device.

Another objective of the present invention is to provide a tire-monitoring device, which starts a transmitter when a vehicle moves on, thereby effectively saving power, reducing times of charging and discharging batteries and increasing a life of the batteries.

To achieve the abovementioned objectives, the present invention provides a tire-monitoring device arranged on at least one tire of a vehicle, and the tire-monitoring device comprises: a tire pressure sensor sensing a tire pressure value of the tire and generating a tire pressure signal according to the tire pressure value; a temperature sensor sensing a temperature value of the tire and generating a temperature signal according to the temperature value; a controller electrically connected with the tire pressure sensor and the temperature sensor to receive the tire pressure signal and the temperature signal, and when the controller determines that the tire pressure value of the tire continuously varies for a preset period according to the tire pressure signal or determines that a rising variation of the temperature value is larger than a preset variation according to the temperature signal, the controller generates a transmission control signal; and a wireless transmitter electrically connected with the controller to receive the transmission control signal and wirelessly transmitting the tire pressure signal and the temperature signal to an external terminal according to the transmission control signal.

Below, the embodiments are described in detail in cooperation with the drawings to make easily understood the technical contents, characteristics and accomplishments of the present invention.

### BRIEF DESCRIPTION OF THE DRAWINGS

FIG. 1 is a diagram schematically showing a usage state of a tire-monitoring device according to an embodiment of the present invention;

FIG. 2 is a block diagram schematically showing a tire-monitoring device according to an embodiment of the present invention;

FIG. 3 is a diagram schematically showing a variation of a tire pressure value according to an embodiment of the present invention; and

FIG. 4 is a diagram schematically showing a variation of a temperature value according to an embodiment of the present invention.

### DETAILED DESCRIPTION OF THE INVENTION

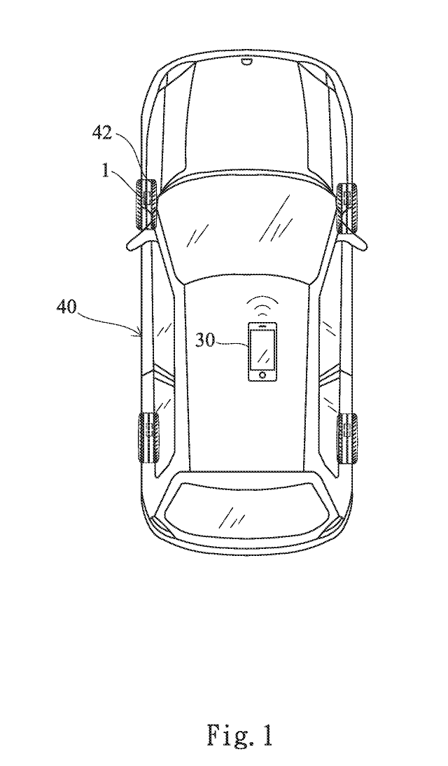

Refer to FIG. 1. The tire-monitoring device 1 of the present invention is arranged on a tire 42 of a vehicle 40. In the embodiment, each tire 42 of the vehicle 40 is provided with a tire-monitoring device 1 to monitor a state of each tire 42.

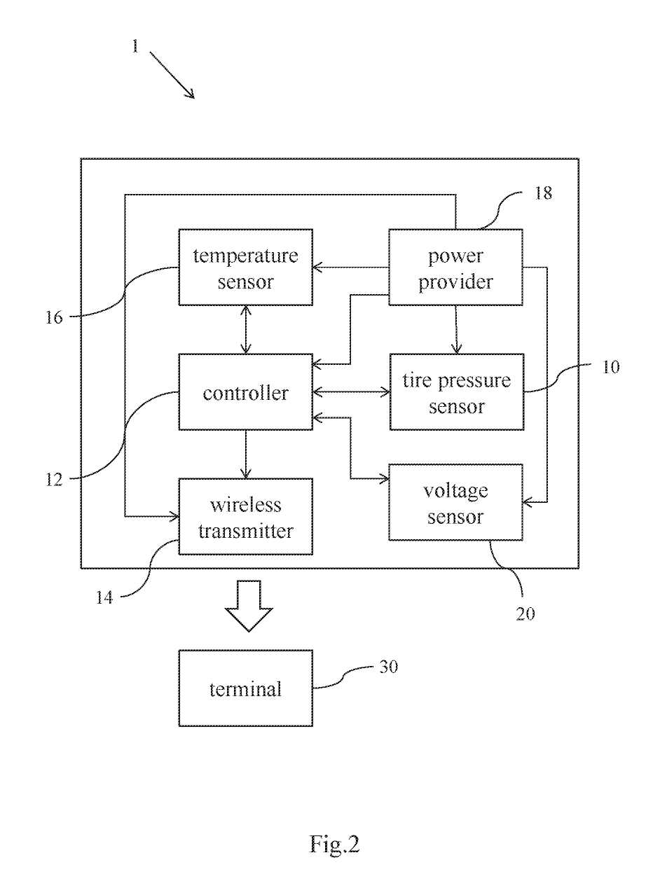

Refer to FIG. 1 and FIG. 2 and the structure of the tire-monitoring device 1 is described in detail. As shown in FIG. 2, each tire-monitoring device 1 comprises a tire pressure sensor 10 arranged on an air valve of the tire 42 and pressured by gas to sense a tire pressure value of the tire 42 to generate a tire pressure signal; a temperature sensor 16 sensing a temperature value of the tire 42 and generating a temperature signal according to the temperature value; a controller 12 electrically connected with the tire pressure sensor 10 and the temperature sensor 16, and in the embodiment, the controller 12 receives the tire pressure signal generated by the tire pressure sensor 10 one time every 30 seconds, and when the controller 12 determines that the tire pressure value of the tire continuously varies for a preset period such as 120 seconds according to the tire pressure signal, the controller 12 generates a transmission control signal; and a wireless transmitter 14 electrically connected with the controller 12 so that the controller 12 transmits the transmission control signal to wireless transmitter 14, wherein the wireless transmitter 14 is a radio frequency transmitter of 300˜455 MHz or a bluetooth transmitter. The wireless transmitter 14 wirelessly transmits the tire pressure signal and the temperature signal to a terminal 30 according to the transmission control signal. For example, when the wireless transmitter 14 receives the transmission control signal transmitted by the controller 12, the wireless transmitter 14 transmits the tire pressure signal and the temperature signal to the terminal 30 every 30 seconds, wherein the terminal 30 is a smart phone or a vehicular computer. The embodiment exemplifies the terminal 30 by a smart phone of a driver. After the smart phone receives the signal transmitted by the wireless transmitter 14, a display of the terminal 30 displays and provides information of the tire 42 such as the tire pressure value to the driver for reference.

The controller 12 further determines that the tire pressure value of the tire 42 stops continuously varying for a preset period such as 300 seconds, the controller 12 stops generating the transmission control signal received by the wireless transmitter 14, whereby the wireless transmitter 14 stops transmitting the tire pressure signal and the temperature signal or reduces times of transmitting the tire pressure signal and the temperature signal. For example, the wireless transmitter 14 transmits the tire pressure signal and the temperature signal one time every 500 seconds lest the wireless transmitter 14 transmit the signals at high frequency, so as to cause power loss.

In addition to using the variation of the tire pressure value to start the wireless transmitter 14, the wireless transmitter 14 further transmits the signal according to the variation of the temperature value in the embodiment. The temperature sensor 16 senses the temperature value of the tire 42 to generate a temperature signal received by the controller 12. The controller 12 determines that a rising variation of the temperature value of the tire 42 is larger than a preset variation such as 5° C. according to the temperature signal, the controller 12 generates the transmission control signal whereby the wireless transmitter 14 transmits the tire pressure signal and the temperature signal to the terminal 30 according to the transmission control signal, so as to use the display of the terminal 30 to display the information of the tire 42.

Certainly, the controller 12 further determines that a decreasing variation of the temperature value of the tire 42 is larger than the preset variation such as 5° C., the controller 12 stops generating the transmission control signal received by the wireless transmitter 14, whereby the wireless transmitter 14 stops transmitting the tire pressure signal and the temperature signal to the terminal 30 or reduces times of transmitting the tire pressure signal and the temperature signal to the terminal 30 lest the wireless transmitter 14 transmit the signals at high frequency, so as to cause power loss.

Refer to FIG. 1 and FIG. 2. In addition to the abovementioned structure, the present invention further comprises a power provider 18 electrically connected with the controller 12, the tire pressure sensor 10, the temperature sensor 16 and the wireless transmitter 14 and providing power to them. The power provider 18 is further electrically connected with a voltage sensor 20 which measures remaining power of the power provider 18. The voltage sensor 20 is further electrically connected with the controller 12 so that the controller 12 transmits the remaining power measured by the voltage sensor 20 to the terminal 30 through the wireless transmitter 14, so as to display the remaining power.

Refer to FIG. 1 and FIG. 2. In the abovementioned embodiment, using the tire pressure value or the temperature value, the controller 12 determines whether to control the wireless transmitter 14 to transmit the tire information to the external terminal. 30, stop transmitting the tire information to the external terminal 30 or reduce frequency of transmitting the tire information to the external terminal 30. In addition to that, when the controller 12 determines that the tire pressure value of the tire pressure signal of the tire pressure sensor 10 continuously varies for a preset period and determines that the rising variation of the temperature value of the temperature signal of the temperature sensor 16 is larger than a preset variation, the controller 12 generates a delivery control signal received by the wireless transmitter 14 whereby the wireless transmitter 14 wirelessly transmits the tire pressure signal and the temperature signal to the terminal 30. Then, when the controller 12 determines that the tire pressure value stops continuously varying for the preset period according to the tire pressure signal of the tire pressure sensor 10 and determines that the decreasing variation of the temperature value is larger than the preset variation according to the temperature signal of the temperature sensor 16, the controller 12 stops generating the delivery control signal received by the wireless transmitter 14 whereby the wireless transmitter 14 stops transmitting the tire pressure signal and the temperature signal or reduces times of transmitting the tire pressure signal and the temperature signal.

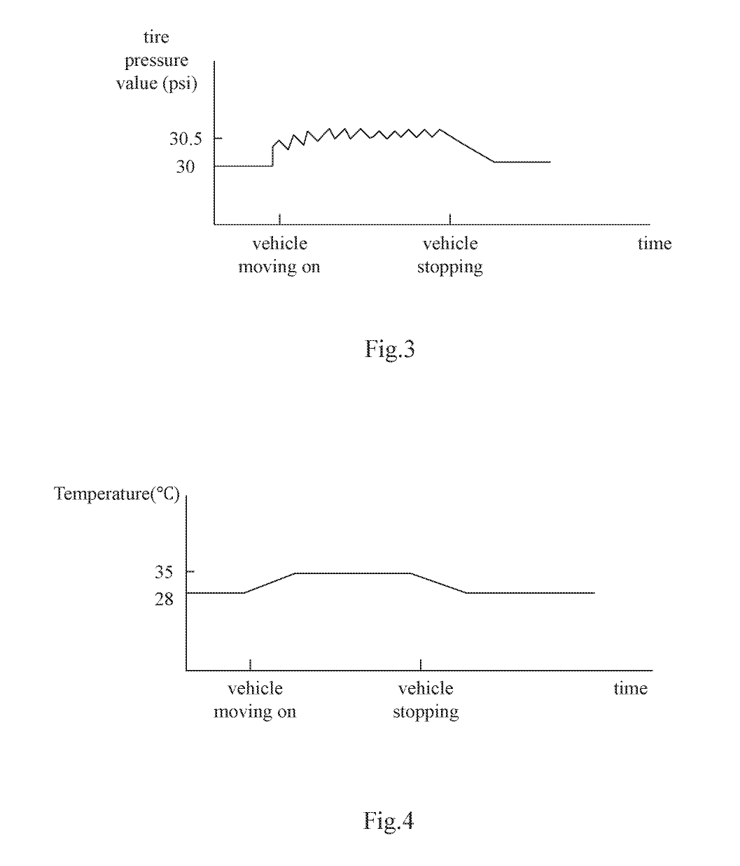

Refer to FIG. 1 to FIG. 3 to describe how to transmit the control signal according to the variation of the tire pressure value in detail in the embodiment. As shown in FIG. 3, when the vehicle 40 is unoccupied, the tire pressure value of the tire 42 is about 30 psi. When a passenger enters the vehicle 40, the tire pressure value is increased by about 0.2 psi. Then, the vehicle 40 starts and moves on. Even the vehicle 40 moves on the flat ground, the tire pressure value continuously varies due to rolling of the tire 42 or the gentle-rolling ground, as shown in the figure. In the embodiment, when the vehicle 40 moves on, the variation of the tire pressure value is about 0.1-0.2 psi. According to the tire pressure signal of the tire pressure sensor 10, the controller 12 observes the present variation of the tire pressure value to determine that the vehicle 40 has moved on. At the same time, transmitting the measured tire pressure value to the external terminal 30 only has meaning, and the controller 12 generate a transmission control signal which controls the wireless transmitter 14 to start to transmit the information including those of the tire pressure, the tire temperature and the voltage of batteries to the terminal 30, and the information is provided to the driver for reference. Then, the vehicle 40 stops moving on, and the tire 42 stops rolling whereby the tire pressure value of the tire 42 stops continuously varying, and the passenger goes out from the vehicle 40 to decrease the tire pressure value. Consequently, the present invention determines that the vehicle 40 has stopped moving on. Meanwhile, according to the tire pressure signal of the tire pressure sensor 10, the controller 12 observes that the present tire pressure value stops continuously varying for 300 seconds to determine that the vehicle 40 has stopped moving on. As a result, the controller 12 stops generating the transmission control signal received by the wireless transmitter 14, whereby the wireless transmitter 14 stops transmitting the tire pressure signal and the temperature signal to the terminal 30 or reduces times of transmitting the tire pressure signal and the temperature signal to the terminal 30 lest the wireless transmitter 14 continuously transmit unnecessary messages to consume unnecessary power and the power provider 18 continuously charge and discharge to shorten its life.

Refer to FIG. 1, FIG. 2 and FIG. 4 to describe how to transmit the control signal according to the variation of the temperature value of the tire 42 in detail in the embodiment. Since the tire 42 rubs against the ground to produce heat when rolling, the temperature of the tire 42 increases during the vehicle 40 moves on. Consequently, the present invention determines that the vehicle 40 has started and moved on. As shown in FIG. 4, when the vehicle 40 starts, the tire 42 rubs against the ground to increase the tire temperature. According to the temperature signal, the controller 12 observes that the rising variation of the temperature value is larger than 5° C. to determine that the vehicle 40 has started and moved on. The controller 12 generates the transmission control signal received by the wireless transmitter 14, whereby the wireless transmitter 14 starts to increase frequency of transmitting the information including those of the tire pressure value and the temperature value to the terminal 30, and the information is provided to the driver for reference. Then, when the vehicle 40 stops moving on and the tire 42 stops rolling, the temperature value of the tire 42 gradually decreases. The temperature value of the temperature sensor 16 has decreased by 5° C. According to that, the controller 12 determines that the vehicle 40 has stopped moving on. As a result, the controller 12 stops generating the transmission control signal received by the wireless transmitter 14, whereby the wireless transmitter 14 stops transmitting the tire pressure signal and the temperature signal to the terminal 30 or decreases frequency of transmitting the tire pressure signal and the temperature signal to the terminal 30 lest the wireless transmitter 14 continuously transmit unnecessary messages to consume power and the power provider 18 continuously charge and discharge to shorten its life.

In conclusion, the present invention uses the variations of the tire pressure value and the tire temperature to turn on or turn off the transmitter lest an assembly be additionally installed to start the transmitter, and avoids damaging the assembly to increase the cost or influencing transmission activities of the tire-monitoring device. The present invention starts the transmitter only when the vehicle moves on, thereby effectively saving power, reducing times of charging and discharging batteries and increasing a life of the batteries.

The embodiments described above are only to exemplify; the present invention but not to limit the scope of the present invention. Therefore, any equivalent modification or variation according to the shapes, structures, features, or spirit disclosed by the present invention is to be also included within the scope of the present invention.

What is claimed is:

1. A tire-monitoring device arranged on at least one tire of a vehicle, and said tire-monitoring device comprising:
a tire pressure sensor sensing a tire pressure value of said tire and generating a tire pressure signal according to said tire pressure value;
a temperature sensor sensing a temperature value of said tire and generating a temperature signal according to said temperature value;
a controller electrically connected with said tire pressure sensor and said temperature sensor to receive said tire pressure signal and said temperature signal, and when said controller determines that said tire pressure value of said tire continuously varies for a preset period according to said tire pressure signal or determines that a rising variation of said temperature value is larger than a preset variation according to said temperature signal, said controller generates a transmission control signal; and
a wireless transmitter electrically connected with said controller to receive said transmission control signal and wirelessly transmitting said tire pressure signal and said temperature signal to outside according to said transmission control signal.

2. The tire-monitoring device of claim 1, wherein after said controller determines that said tire pressure value of said tire stops continuously varying for said preset period, said controller stops generating said transmission control signal received by said wireless transmitter, whereby said wireless transmitter stops transmitting said tire pressure signal or reduces times of transmitting said tire pressure signal.

3. The tire-monitoring device of claim 2, wherein after said controller determines that said decreasing variation of said temperature value of said tire is larger than said preset variation, said controller stops generating said transmission control signal received by said wireless transmitter, whereby said wireless transmitter stops transmitting said temperature signal or reduces times of transmitting said temperature signal.

4. The tire-monitoring device of claim 2, further comprising a terminal having a display, and said terminal receives said tire pressure signal and said temperature signal, and said display displays said tire pressure value and said temperature value.

5. The tire-monitoring device of claim 4, wherein said terminal is a smart phone or a vehicular computer.

6. The tire-monitoring device of claim 1, wherein said wireless transmitter is a radio frequency transmitter or a bluetooth transmitter,

7. The tire-monitoring device of claim 4, further comprising a power provider electrically connected with said tire pressure sensor, said temperature sensor, said controller, said wireless transmitter and providing power to said tire pressure sensor, said temperature sensor, said controller, said wireless transmitter.

8. The tire-monitoring device of claim 7, further comprising a voltage sensor electrically connected with said power provider to measure remaining power of said power provider.

9. The tire-monitoring device of claim 1, wherein when said controller determines that said tire pressure value continuously varies for said preset period according to said tire pressure signal of said tire pressure sensor and determines that said rising variation of said temperature value is larger than said preset variation according to said temperature signal of said temperature sensor, said controller generates a delivery control signal received by said wireless transmitter whereby said wireless transmitter wirelessly transmits said tire pressure signal and said temperature signal to outside; when said controller determines that said tire pressure value stops continuously varying for said preset period according to said tire pressure signal of said tire pressure sensor and determines that said decreasing variation of said temperature value is larger than said preset variation according to said temperature signal of said temperature sensor, said controller stops generating said delivery control signal received by said wireless transmitter whereby said wireless transmitter stops transmitting said tire pressure signal and said temperature signal or reduces times of transmitting said tire pressure signal and said temperature signal.
